(19) United States
(12) Patent Application Publication
(10) Pub. No.: US 2026/0197864 A1
(43) Pub. Date: Jul. 9, 2026

(54) TRANSMISSION MODES FOR JOINT DATA AND SENSING SIGNALS

(71) Applicant: HUAWEI TECHNOLOGIES CO., LTD., Shenzhen (CN)

(72) Inventors: Mohammad Javad Emadi, Lund (SE); Sha Hu, Lund (SE); Dzevdan Kapetanovic, Lund (SE)

(73) Assignee: HUAWEI TECHNOLOGIES CO., LTD., Shenzhen (CN)

(21) Appl. No.: 19/552,803

(22) Filed: Feb. 27, 2026

Related U.S. Application Data
(63) Continuation of application No. PCT/EP2023/073954, filed on Aug. 31, 2023.

(51) Int. Cl. H04W 74/0808; H04W 56/00; H04W 72/231; H04W 72/51

(52) U.S. Cl. CPC H04W 74/0808; H04W 56/0015; H04W 72/231; H04W 72/51

(57) ABSTRACT

Embodiments of the invention relate to a first communication device (100) configured to operate in different transmission modes. When operating in a first transmission mode (TM1), the first communication device (100) transmits a data signal to a second communication device (300). When operating in a second transmission mode (TM2), the first communication device (100) transmits a joint data and sensing signal to a second communication device (300). In a corresponding way, the second communication device (300) may operate in a first reception mode (RM1) to receive the data signal from the first communication device (100) and in a second reception mode (RM2) to receive the joint data and sensing signal from the first communication device (100). Data and sensing information can thereby be transmitted and/or received in a flexible and efficient way. Furthermore, the invention also relates to corresponding methods and a computer program.

### CROSS-REFERENCE TO RELATED APPLICATIONS

This application is a continuation of International Application No. PCT/EP2023/073954, filed on Aug. 31, 2023, the disclosure of which is hereby incorporated by reference in its entirety.

### TECHNICAL FIELD

Embodiments of the invention relate to a first communication device operating in different transmission modes and a second communication device operating in different reception modes. Furthermore, embodiments of the invention also relate to corresponding methods and a computer program.

### BACKGROUND

Reliable communications and sensing are the two main pillars for beyond fifth generation (B5G) networks. Traditionally communication systems and sensing systems are independently designed. Different waveforms, different frequency bands, independent hardware (HW), and distinct performance metrics are typically used for these two systems, which is not efficient from spectral-, energy-, HW-efficiency, and joint-design. Recently, integrated sensing and communications (ISAC) has gained interests not only to improve the efficiencies, but also to improve performance of the communications by using the sensing signal, which is called sensing-assisted communications, or to improve the sensing quality by using the communication signals, which is named communication-assisted sensing. The two streams may further be jointly design which is called joint-communications-and-sensing (JCAS).

The ISAC approach has a wide range of use cases, such as object detection and constructing environment map in delay-Doppler-spatial domain, high accuracy positioning and tracking, improved channel state information (CSI) estimation and tracking, enhanced radio management, imaging and environment reconstruction, and sensing environment e.g., target detection, event detection, environment detection. Therefore, a practical and efficient ISAC framework is of important. Since orthogonal frequency-division multiplexing (OFDM) transmission is widely used in wireless networks, a candidate to perform communications and sensing could be based on the OFDM waveform and its frame structure in 5G NR.

### SUMMARY

An objective of embodiments of the invention is to provide a solution which mitigates or solves the drawbacks and problems of conventional solutions.

Another objective of embodiments of the invention is to provide a solution for efficient and flexible transmission of joint data and sensing.

The above and further objectives are solved by the subject matter of the independent claims. Further embodiments of the invention can be found in the dependent claims.

According to a first aspect of the invention, the above mentioned and other objectives are achieved with a first communication device configured to:
operate in a first transmission mode comprising transmitting a data signal to a second communication device; and
operate in a second transmission mode comprising transmitting a joint data and sensing signal to a second communication device.

An advantage of the first communication device according to the first aspect is that the first communication device can support both communication and sensing services in a flexible way. Communication may herein also be referred to or denoted as data communication. Also, by using the different transmission modes, the first communication device can support different classes of waveforms and signaling for data transmissions and/or sensing signals based on the capabilities of the second communication device. The proposed scheme is fully compatible with 5G NR signaling to have a minor impact on current standards especially for data transmissions. Moreover, the first communication device can efficiently utilize its HW for the dual usage to improve spectral-, energy-, and HW-efficiency.

In an implementation form of a first communication device according to the first aspect, the data signal is a 3GPP standard data signal.

An advantage with this implementation form is that the data transmission format for 3GPP communications is not changed. Thus, the legacy frame structure can be configured to support data transmission and therefore it does not affect a legacy second communication device such as a legacy user equipment (UE) which is not interested in sensing capabilities. Moreover, by using the first and second transmission modes, both sensing and communication purposes can be achieved using the standard frame structure of the 3GPP standard.

In an implementation form of a first communication device according to the first aspect, the joint data and sensing signal comprises a data signal and a sensing signal being separated in the time domain, in the frequency domain and/or in the spatial domain.

An advantage with this implementation form is that communication and sensing can be separately supported in orthogonal domains with proper resource allocation management in frequency-, time-, and spatial-domain. The separate mode is easy to implement by configuring the available parameters and utilizing the available HW and resources.

In an implementation form of a first communication device according to the first aspect, the joint data and sensing signal comprises a data signal superimposed on a sensing signal, or vice versa.

An advantage with this implementation form is that the spectral- and HW-efficiencies can be maximized by superimposing communication and sensing signals. By properly designing the sensing waveforms, the possible interference on the communication signal can be controlled. Furthermore, by aligning the sensing signal, interference-free communications can be supported. Therefore, if the legacy UE is not aware of the sensing mode, the legacy UE can still recover the data, and the UE with sensing capability can detect data while sensing the channel/environment as well. Joint communication and sensing transmissions are thereby supported without sacrificing efficiencies and resources.

In an implementation form of a first communication device according to the first aspect, the first communication device is configured to:
operate in the second transmission mode after having received a sensing request message from the second communication device or after having transmitted a sensing request message to the second communication device, the sensing request message indicating reception or transmission of the joint data and sensing signal.

An advantage with this implementation form is that the sensing procedure can be initiated by either of the communication devices. Therefore, a wide range of sensing services and applications can be supported based on the sensing request and device capabilities. For example, the second communication device can request sensing to detect intrusion, to monitor the environment such as the temperature, humidity, etc., or to detect obstacles around it. On the other hand, the first communication device can request sensing to detect the possible blockage/obstacles around the second communication device and use the sensing information for possible usage such as beam management, resource allocations etc.

In an implementation form of a first communication device according to the first aspect, the first communication device is configured to:
receive a sensing capability message from the second communication device, the sensing capability message indicating a sensing capability of the second communication device; and
operate in the first transmission mode or in the second transmission mode based on the sensing capability message.

An advantage with this implementation form is that the first communication device can support different types of second communication devices, i.e., the legacy second communication device and the second communication device with sensing capability. Also, based on the received sensing capability message from the second communication device, the first communication device can decide which transmission mode to operate in to support the requested message and can also manage the sensing waveform's parameters.

In an implementation form of a first communication device according to the first aspect, the first communication device is configured to:
transmit a transmission mode message to the second communication device, the transmission mode message indicating the first communication device transmitting the data signal or the joint data and sensing signal.

An advantage with this implementation form is that the second communication device is informed about and can tune to the transmission mode used by the first communication device, making the transmission more flexible and enabling sensing feature to be added to the communication systems. The sensing procedure and sensing goal, e.g., sensing resolution and applications, can be flexibly configured based on the capability of the second communication device.

In an implementation form of a first communication device according to the first aspect, the transmission mode message further indicates one or more parameters for the joint data and sensing signal in the group comprising: a start time instance, a stop time instance, a transmission bandwidth, and a sensing signal waveform.

An advantage with this implementation form is that the second communication device becomes aware of the waveform parameters and the configuration to perform sensing search and achieve reliable sensing performance, thereby enabling the second communication device to obtain the sensing signal. For instance, to detect static/low-speed/high-speed objects with various sensing resolutions various parameters for the joint data and sensing signal can be configured based on the applications.

In an implementation form of a first communication device according to the first aspect, the transmission mode message is any of: a downlink control information, DCI, a radio resource control, RRC, or a synchronization signal block, SSB.

An advantage with this implementation form is that available control signaling can be used and/or re-configured to support communication and sensing services.

According to a second aspect of the invention, the above mentioned and other objectives are achieved with a second communication device configured to:
operate in a first reception mode comprising receiving a data signal from a first communication device; and
operate in a second reception mode comprising receiving a joint data and sensing signal from a first communication device.

An advantage of the second communication device according to the second aspect is that it can work as a legacy second communication device or a second communication device with sensing capabilities. By supporting the second reception mode, the second communication device can support a wide range of sensing applications and services based on the capabilities of the second communication device, such as indoor and outdoor intrusion detections, obstacle detection and avoidance, blockage detection and beam management, multi path component detection and parameter estimations of the wireless channel, etc.

In an implementation form of a second communication device according to the second aspect, the data signal is a 3GPP standard data signal.

An advantage with this implementation form is that the data transmission format for 3GPP communications is not changed. Thus, the legacy frame structure can be configured to support data transmission and therefore it does not affect a legacy second communication device which is not interested in sensing capabilities. Moreover, by using the first and second reception modes, both sensing and communication purposes can be achieved using the standard frame structure of the 3GPP standard.

In an implementation form of a second communication device according to the second aspect, the joint data and sensing signal comprises a data signal and a sensing signal being separated in the time domain, in the frequency domain and/or in the spatial domain.

An advantage with this implementation form is that communication and sensing can be separately supported in orthogonal domains with proper resource allocation management in frequency-, time-, and spatial-domain. The separate mode is easy to implement by configuring the available parameters and utilizing the available HW and resources.

In an implementation form of a second communication device according to the second aspect, the joint data and sensing signal comprises a data signal superimposed on a sensing signal, or vice versa.

An advantage with this implementation form is that the spectral- and HW-efficiencies can be maximized by superimposing communication and sensing signals. By properly designing the sensing waveforms, the possible interreference on the communication signal can be controlled. Furthermore, by aligning the sensing signal, interference-free communications can be supported. Therefore, if the legacy UE is not aware of the sensing mode, the legacy UE can still recover the data, and the UE with sensing capability can detect data while sensing the channel/environment as well. Joint communication and sensing transmissions are thereby supported without sacrificing efficiencies and resources.

In an implementation form of a second communication device according to the second aspect, the second communication device is configured to:
transmit a sensing request message to the first communication device previous to receiving the joint data and sensing signal, the sensing request message indicating reception of the joint data and sensing signal.

An advantage with this implementation form is that the sensing procedure can be initiated by the second communication devices. Therefore, a wide range of sensing services and applications could be supported based on the sensing request and device capabilities. For example, the second communication device can request sensing to detect intrusion, to monitor the environment such as the temperature, humidity, etc., or to detect obstacles around it.

In an implementation form of a second communication device according to the second aspect, the second communication device is configured to:
transmit a sensing capability message to the first communication device, the sensing capability message indicating a sensing capability of the second communication device.

An advantage with this implementation form is that the first communication device can be informed about the sensing capabilities of the second communication device and can decide which transmission mode to operate in towards the second communication device.

In an implementation form of a second communication device according to the second aspect, the second communication device is configured to:
receive a transmission mode message from the first communication device, the transmission mode message indicating the first communication device transmitting the data signal or the joint data and sensing signal.

An advantage with this implementation form is that the second communication device is informed about and can tune to the transmission mode used by the first communication device, making the transmission more flexible and enabling sensing feature to be added to the communication systems. The sensing procedure and sensing goal, e.g., sensing resolution and applications, can be flexibly configured based on the capability of the second communication device.

In an implementation form of a second communication device according to the second aspect, in the transmission mode message further indicates one or more parameters for the joint data and sensing signal in the group comprising: a start time instance, a stop time instance, a transmission bandwidth, and a sensing signal waveform.

An advantage with this implementation form is that the second communication device becomes aware of the waveform parameters and the configuration to perform sensing search and achieve reliable sensing performance, thereby enabling the second communication device to obtain the sensing signal. For instance, to detect static/low-speed/high-speed objects with various sensing resolutions various parameters for the joint data and sensing signal can be configured based on the applications.

In an implementation form of a second communication device according to the second aspect, the transmission mode message is any of: a DCI, an RRC or an SSB.

An advantage with this implementation form is that available control signaling can be used and/or re-configured to support communication and sensing services.

According to a third aspect of the invention, the above mentioned and other objectives are achieved with a method for a first communication device, the method comprises:
operating in a first transmission mode comprising transmitting a data signal to a second communication device; and
operating in a second transmission mode comprising transmitting a joint data and sensing signal to a second communication device.

The method according to the third aspect can be extended into implementation forms corresponding to the implementation forms of the first communication device according to the first aspect. Hence, an implementation form of the method comprises the feature(s) of the corresponding implementation form of the first communication device.

The advantages of the methods according to the third aspect are the same as those for the corresponding implementation forms of the first communication device according to the first aspect.

According to a fourth aspect of the invention, the above mentioned and other objectives are achieved with a method for a second communication device, the method comprises:
operating in a first reception mode comprising receiving a data signal from a first communication device; and
operating in a second reception mode comprising receiving a joint data and sensing signal from a first communication device.

The method according to the fourth aspect can be extended into implementation forms corresponding to the implementation forms of the second communication device according to the second aspect. Hence, an implementation form of the method comprises the feature(s) of the corresponding implementation form of the second communication device.

The advantages of the methods according to the fourth aspect are the same as those for the corresponding implementation forms of the second communication device according to the second aspect.

Embodiments of the invention also relate to a computer program, characterized in program code, which when run by at least one processor causes the at least one processor to execute any method according to embodiments of the invention. Further, embodiments of the invention also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 shows a first communication device according to an embodiment of the invention;

FIG. 2 shows a flow chart of a method for a first communication device according to an embodiment of the invention;

FIG. 3 shows a second communication device according to an embodiment of the invention;

FIG. 4 shows a flow chart of a method for a second communication device according to an embodiment of the invention;

FIG. 5 shows a communication system according to an embodiment of the invention; and

FIG. 6 shows transmission modes for different second communication devices according to an embodiment of the invention;

FIG. 7 shows a type I frame structure for the second transmission mode according to an embodiment of the invention;

FIG. 8 shows a type II frame structure for the second transmission mode according to another embodiment of the invention;

FIG. 9 shows signaling related to transmission mode selection according to an embodiment of the invention; and

FIG. 10 shows joint data and sensing signal construction according to an embodiment of the invention.

### DETAILED DESCRIPTION

The OFDM waveform and its frame structure in 5G NR is a candidate for performing communications and sensing. However, the OFDM waveform may not the best option for double selective channels, i.e., high dispersive channel in the delay and Doppler domain. Especially in high Doppler channels, the performance of the OFDM system degrades for both sensing and communications systems, due to the inter-carrier interference (ICI). For example, the channel estimations quality and bit error rate (BER) degrade and also OFDM-based time-of-arrival (ToA) and positioning estimations may not achieve the required accuracy. On the other hand, in multipath channel, although by increasing the cyclic prefix (CP), the effect of inter symbol interfere (ISI) can be controlled, the spectral efficiency may decrease. Furthermore, the ToA and positioning estimations could still be complex since the effect of multipath must be iteratively resolved in time/frequency domain and complexity cost is high.

In summary, the OFDM waveform is good for communication, but not so good for sensing in special scenarios. To overcome these issues, the orthogonal time frequency space (OTFS) waveform is proposed to replace OFDM, but OTFS also has drawbacks especially for data transmissions. Therefore, in 5G-NR and its evolutions, there is a need to support both OFDM transmissions and sensing transmissions.

How to manage sensing and communications has been discussed in recent 3GPP meetings. One way is to use orthogonal sensing and communications transmissions, e.g., different time-slots or different frequency bands, or to use available reference signals to perform sensing and communications, which is not a joint design approach. The need for new waveform designs for sensing and communications is also under discussions.

According to embodiments of the invention a solution for supporting different transmission modes to enable sensing and communications in 5G-NR and its future evaluations is therefore provided. The solution enables a flexible transmission mode configuration in various scenarios to support both legacy user equipment (UEs) without sensing features and more advanced ISAC UEs that can cooperate with the network to support sensing features.

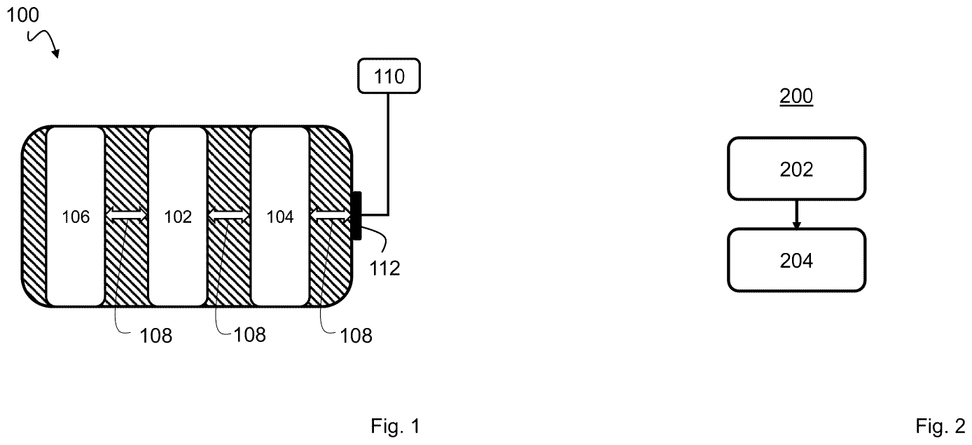

FIG. 1 shows a first communication device 100 according to an embodiment of the invention. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 may be configured for wireless and/or wired communications in a communication system. The wireless communication capability may be provided with an antenna or antenna array 110 coupled to the transceiver 104, while the wired communication capability may be provided with a wired communication interface 112 e.g., coupled to the transceiver 104.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset.

That the first communication device 100 is configured to perform certain actions can in this disclosure be understood to mean that the first communication device 100 comprises suitable means, such as e.g., the processor 102 and the transceiver 104, configured to perform the actions.

According to embodiments of the invention the first communication device 100 is configured to operate in a first transmission mode TM1 comprising transmitting a data signal to a second communication device 300; and operate in a second transmission mode TM2 comprising transmitting a joint data and sensing signal to a second communication device 300.

Furthermore, in an embodiment of the invention, the first communication device 100 for a communication system 500 comprises a transceiver configured to: operate in a first transmission mode TM1 comprising transmitting a data signal to a second communication device 300; and operate in a second transmission mode TM2 comprising transmitting a joint data and sensing signal to a second communication device 300.

Moreover, in yet another embodiment of the invention, the first communication 100 for a communication system 500 comprises a processor and a memory having computer readable instructions stored thereon which, when executed by the processor, cause the processor to: operate in a first transmission mode TM1 comprising transmitting a data signal to a second communication device 300; and operate in a second transmission mode TM2 comprising transmitting a joint data and sensing signal to a second communication device 300.

FIG. 2 shows a flow chart of a corresponding method 200 which may be executed in a first communication device 100, such as the one shown in FIG. 1. The method 200 comprises operating 202 in a first transmission mode TM1 comprising transmitting a data signal to a second communication device 300; and operating 204 in a second transmission mode TM2 comprising transmitting a joint data and sensing signal to a second communication device 300.

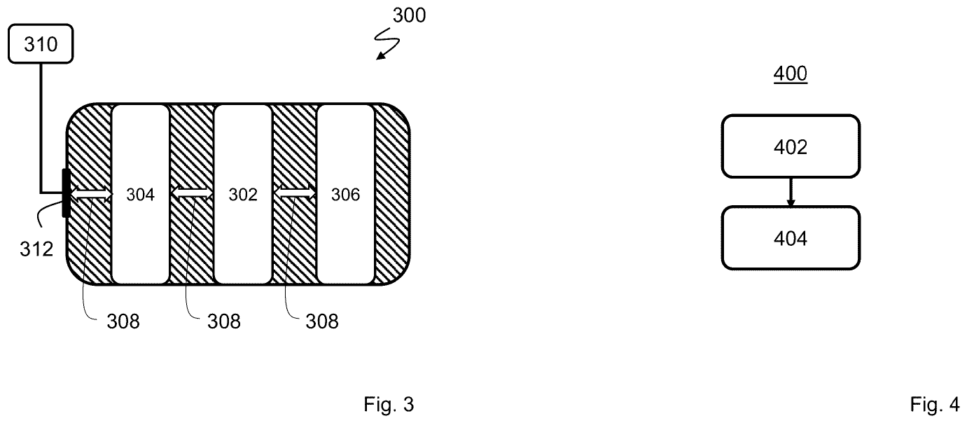

FIG. 3 shows a second communication device 300 according to an embodiment of the invention. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 may be configured for wireless and/or wired communications in a communication system. The wireless communication capability may be provided with an antenna or antenna array 310 coupled to the transceiver 304, while the wired communication capability may be provided with a wired communication interface 312 e.g., coupled to the transceiver 304.

The processor 302 may be referred to as one or more general-purpose CPUs, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 304 may be a transceiver circuit, a power controller, or an interface providing capability to communicate with other communication modules or communication devices. The transceiver 304, the memory 306 and/or the processor 302 may be implemented in separate chipsets or may be implemented in a common chipset.

That the second communication device 300 is configured to perform certain actions can in this disclosure be understood to mean that the second communication device 300 comprises suitable means, such as e.g., the processor 302 and the transceiver 304, configured to perform the actions.

According to embodiments of the invention the second communication device 300 is configured to operate in a first reception mode RM1 comprising receiving a data signal from a first communication device 100; and operate in a second reception mode RM2 comprising receiving a joint data and sensing signal from a first communication device 100.

Furthermore, in an embodiment of the invention, the second communication device 300 for a communication system 500 comprises a transceiver configured to: operate in a first reception mode RM1 comprising receiving a data signal from a first communication device 100; and operate in a second reception mode RM2 comprising receiving a joint data and sensing signal from a first communication device 100.

Moreover, in yet another embodiment of the invention, the second communication device 300 for a communication system 500 comprises a processor and a memory having computer readable instructions stored thereon which, when executed by the processor, cause the processor to: operate in a first reception mode RM1 comprising receiving a data signal from a first communication device 100; and operate in a second reception mode RM2 comprising receiving a joint data and sensing signal from a first communication device 100.

FIG. 4 shows a flow chart of a corresponding method 400 which may be executed in a second communication device 300, such as the one shown in FIG. 3. The method 400 comprises operating 402 in a first reception mode RM1 comprising receiving a data signal from a first communication device 100; and operating 404 in a second reception mode RM2 comprising receiving a joint data and sensing signal from a first communication device 100.

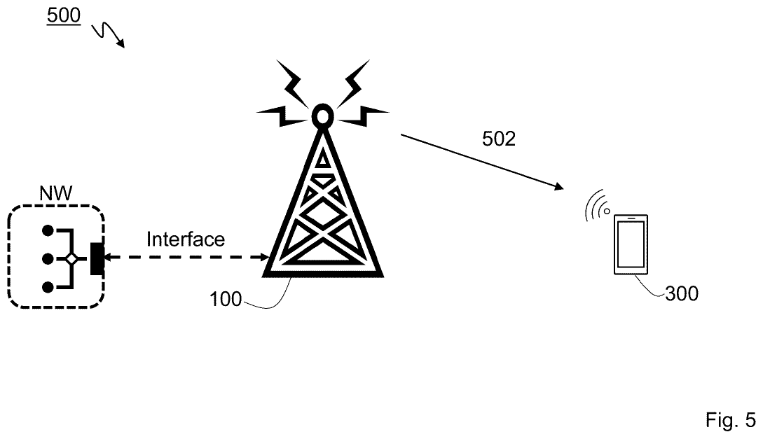

FIG. 5 shows a communication system 500 according to an embodiment of the invention. The communication system 500 in the disclosed embodiment comprises a first communication device 100 and a second communication device 300 configured to communicate and operate in the communication system 500. In the shown embodiment, the first communication device 100 is configured as a network access node and the second communication device 300 is configured as a client device. However, in embodiments the first communication device 100 may be configured as a client device and the second communication device 300 may be configured as a client device or a network access node. The first communication device 100 being a network access node may be connected to a network NW such as e.g., a core network over a communication interface. The communication system 500 may be a communication system according to the 3GPP standard such as e.g., a 5G system in which case the client device may be a UE and the network access node may be a next generation node B (gNB) but the invention is not limited thereto.

According to embodiments of the invention the first communication device 100 is configured to operate in a first transmission mode TM1 and a second transmission mode TM2. When operating in the first transmission mode TM1, the first communication device 100 transmits a data signal to the second communication device 300. When operating in the second transmission mode TM2, the first communication device 100 transmits a joint data and sensing signal to the second communication device 300. In embodiments, more than two transmission modes may be defined and the first communication device 100 may hence operate in two or more different transmission modes TM1, TM2, . . . , TMn.

With reference to FIG. 5, a signal 502 transmitted from the first communication device 100 to the second communication device 300 may hence be a data signal or a joint data and sensing signal depending on whether the first communication device 100 operates in the first transmission mode TM1 or the second transmission mode TM2. The first communication device 100 may switch between the two transmission modes TM1, TM2 when transmitting signals to the second communication device 300, e.g., based on whether sensing is requested for the second communication device 300. The first communication device 100 may further operate in the first transmission mode TM1 towards the second communication device 300 and in the second transmission mode TM2 towards another second communication device 300′, or vice versa.

In a corresponding way, the second communication device 300 may operate in at least two different reception modes to receive the signal 502 transmitted from the first communication device 100. When the second communication device 300 operates in a first reception mode RM1, the second communication device 300 receives the data signal from the first communication device 100. When the second communication device 300 operates in a second reception mode RM2, the second communication device 300 receives the joint data and sensing signal from the first communication device 100.

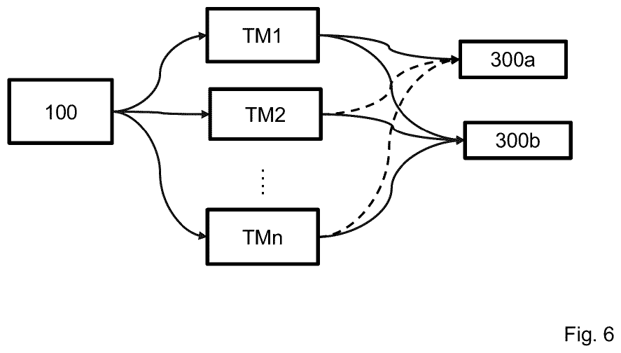

The first communication device 100 may select the transmission mode TM1, TM2, . . . , TMn based on e.g., sensing capability of the receiving second communication device 300 and sensing request, as shown in FIG. 6. FIG. 6 shows transmission modes for different second communication devices according to an embodiment of the invention. In the embodiment shown in FIG. 6, it is assumed that one second communication device 300a is a legacy device without sensing capability and that the other second communication device 300b has sensing capability. As indicated with solid arrows in FIG. 6, the transmission mode TM1 for transmission of data signals may be used to any of the second communication devices 300a, 300b. The transmission mode TM2 for transmission of joint data and sensing signals may typically be used for transmissions to the second communication device 300b with sensing capabilities. However, as indicated with dashed arrows transmission using the transmission mode TM2 may be transparent to the second communication device 300a without sensing capability, i.e., the second communication device 300a may receive and process the data signal in the joint data and sensing signal and ignore the sensing signal.

Further transmissions modes TMn for other ways of transmitting data and sensing jointly may be defined and used towards second communication devices 300b with sensing capabilities, as indicated in FIG. 6. For example, a further transmission mode TMn may be defined for mono-static sensing, where the first communication device 100 and the second communication device 300 are the same communication device and is equipped with multiple-transmit and multiple-receive antennas. One of the possible ways of transmitting a data and sensing signal in this case is to generate one signal but in two directions, i.e., separated in the spatial domain, one direction for the data signal and one direction for the sensing signal. Thus, the second communication device 300a without sensing capabilities does not need to be aware of the sensing signal. On the other hand, the second communication device 300b with sensing capabilities may search the echoes of the received signals from specific directions to search for possible targets. In addition, further transmissions modes TMn may be defined to handle specific sensing reference signals or specific waveforms defined in future releases of the 3GPP standard.

The data signal may be a 3GPP standard data signal such as e.g., OFDM or discrete Fourier transforms (DFTs)-OFDM. The first transmission mode TM1 may hence be a legacy transmission mode in which the first communication device 100 transmits data signals with the standard OFDM waveform, e.g., the 5G-NR OFDM waveform. When operating in the first transmission mode TM1, the first communication device 100 may act as a conventional 5G-NR transceiver. The first communication device 100 may operate in the first transmission mode TM1 when there is no request for sensing, i.e., there is no sensing signal to be transmitted to the second communication device 300. In a corresponding way, the first reception mode RM1 may be a legacy reception mode for the second communication device 300 to receive 3GPP standard data signals such as e.g., OFDM or DFTs-OFDM.

The second transmission mode TM2 may be used when sensing has been requested, i.e., when both data and sensing information is to be transmitted to the second communication device 300. The data and sensing information may be transmitted using a joint data and sensing signal. The joint data and sensing signal may be constructed in different ways, e.g., using multiplexing, interleaving or superimposing techniques.

In embodiments, the joint data and sensing signal may comprise a data signal and a sensing signal being separated in the time domain, in the frequency domain and/or in the spatial domain. The data signal may e.g., be multiplexed and/or interleaved with the sensing signal in the time domain, in the frequency domain and/or in the spatial domain. The sensing signal may be OFDM compatible or another predefined sensing signal. In embodiments, the sensing signal may be an available or modified reference signal defined in 5G-NR in uplink or downlink. The sensing signal may further be a future specific OFDM-based or OFDM-compatible sensing reference signal. During the transmission of the sensing signal in the time, frequency and/or spatial resources, there may be no data signal transmission. When the data signal and the sensing signal is separated in the time domain, in the frequency domain and/or in the spatial domain, the data transmission may hence be discontinuous. The second transmission mode TM2 may in this case be referred to as a low data payload mode.

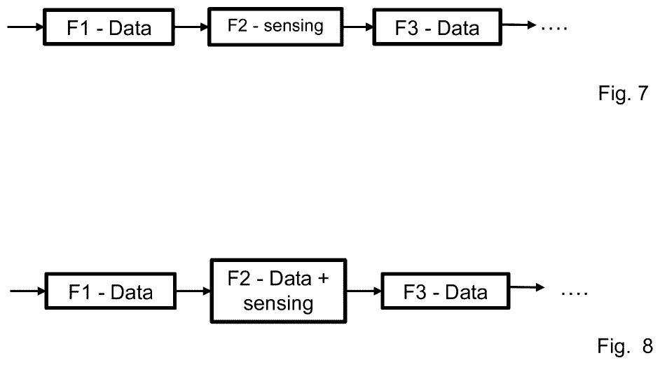

FIG. 7 shows a frame structure for transmission of a data signal and a sensing signal separated in the time domain according to an embodiment of the invention. In a first subframe F1, the first communication device 100 transmits a data signal and in a subsequent second subframe F2 the first communication device 100 transmits a sensing signal. In a third subframe F3, after the second subframe F2, the first communication device 100 again transmits a data signal. In the frame structure shown in FIG. 7, which is herein denoted a type I frame structure, each subframe comprises either a data signal or a sensing signal. When the sensing signal is transmitted no data signal is transmitted, or vice versa. The type I frame structure hence leads to discontinuous data transmission and may be referred to as a low data payload mode. The type I frame structure may e.g., be used to support legacy communication devices without sensing capability or to support orthogonal resource allocation for sensing and communication.

In embodiments, the joint data and sensing signal comprises a data signal superimposed on a sensing signal, or vice versa. The sensor signal part may e.g., be superimposed with existing OFDM samples in a cyclic prefix part of an OFDM symbol comprising the cyclic prefix part and a data part. The sensor signal part may e.g., be overlayed in the cyclic prefix part, i.e., the sensor signal may be arranged on top of one or more cyclic prefix samples. The sensor signal part may further be arranged in an empty time slot of the cyclic prefix part. The empty time slot may be obtained by muting one or more cyclic prefix samples, e.g., not transmitting or removing one or more cyclic prefix samples. When the joint data and sensing signal is based on superimposing the data and sensing signal, a continuous data transmission can be achieved. The second transmission mode TM2 may in this case be referred to as a high data payload mode.

FIG. 8 shows a frame structure for transmission of a data signal superimposed on a sensing signal, or vice versa, according to an embodiment of the invention. In a first subframe F1, the first communication device 100 transmits a data signal and in a subsequent second subframe F2, the first communication device 100 transmits a data signal plus a sensing signal, where the data signal is superimposed on the sensing signal, or vice versa. In a third subframe F3, after the second subframe F2, the first communication device 100 again transmits only a data signal. In the frame structure shown in FIG. 8, which is herein denoted a type II frame structure, a subframe may comprise data or data plus sensing. In this way, continuous data transmission can be achieved. The type II frame structure may hence support continuous data transmission without abruptions in time and may be referred to as a high data payload mode. The type II frame structure supports more advanced joint design of data and sensing signals such as the mentioned superimposed transmissions.

Each transmission mode TM1, TM2, . . . , TMn may be associated with a binary form/format such as a binary index to identify the transmission modes TM1, TM2, . . . , TMn. Table 1 shows transmission mode definitions according to an embodiment of the invention. This association table may be defined by the network to support different transmission modes. The transmission mode configurations may be configured based on this table or any other suitable representation of the different transmission modes.

TABLE 1

| Binary form (N bits) | TM |
|---|---|
| 00 . . . 00 | TM1: legacy OFDM Mode |
| 00 . . . 01 | TM2 type I frame structure: Separate data |
| | and sensing |
| 00 . . . 10 | TM2 type II frame structure: Superimposed |
| | data and sensing |
| . . . | . . . |
| 11 . . . 11 | TMn |

Binary forms may further be used to define transmission mode configurations, as shown in table 2. A transmission mode configuration may comprise a set of parameters for configuring the transmission mode. The set of parameters may e.g., include control signaling, type and/or capability of the second communication device, sensing parameters, sensing requirements/resolutions, etc. The sensing parameters may include a number of targets and parameters related to the number of targets to feedback after sensing measurements such as e.g., delay, Doppler, angle of arrival, angle of departure, and radar cross sections (RCS) of each target. The sensing parameters may further include type of sensing waveform, transmission bandwidth, transmission start time, transmission stop time, and sensing pattern. Each transmission mode and transmission mode configuration may have different parameter settings. For example, if the first transmission mode TM1 is active, there is no specific configuration for sensing in the transmission mode configuration, but if the second transmission mode TM2 is active, frame type, transmission bandwidth, start time, stop time, sensing waveform structure, sensing goal, etc. may be defined in the transmission mode configuration. So, the transmission mode configuration is dependent of the transmission mode.

TABLE 2

| Binary form (M bits) | TM |
|---|---|
| 00 . . . 00 | Configuration of TM1 for legacy OFDM |
| | Mode |
| 00 . . . 01 | Configuration of TM2 type I frame structure |
| | for separate data and sensing |
| 00 . . . 10 | Configuration of TM2 type II frame structure |
| | for superimposed data and sensing |
| . . . | . . . |
| 11 . . . 11 | Configuration of TMn |

The first communication device 100 may operate in the first transmission mode TM1 when sensing is not active, i.e., when no sensing signal is to be transmitted. In embodiments, the first transmission mode TM1 may be a default transmission mode. When sensing is activated, e.g., based on a sensing request, the first communication device 100 may change to operating in the second transmission mode TM2. The sensing request may be initiated by the first communication device 100 or the second communication device 300. The sensing request may further be initiated by a network node or another communication device.

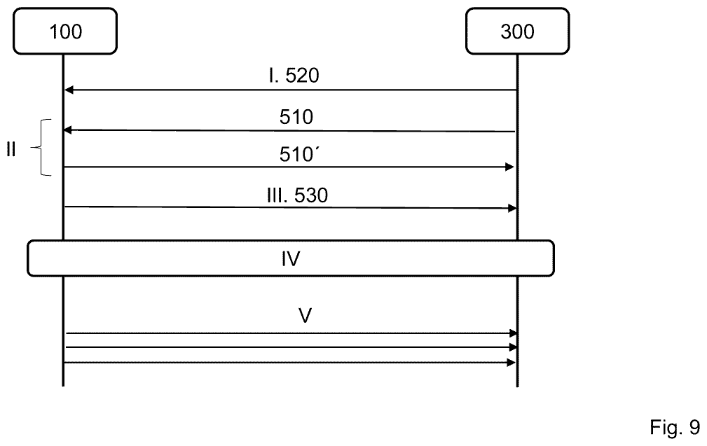

FIG. 9 shows signaling between the first communication device 100 and the second communication device 300 for determining transmission and reception mode according to an embodiment of the invention. In step I, the second communication device 300 transmits a sensing capability message 520 to the first communication device 100, the sensing capability message 520 indicating a sensing capability of the second communication device 300.

The first communication device 100 receives the sensing capability message 520 from the second communication device 300 and hence obtains the sensing capability of the second communication device 300 indicated in the sensing capability message 520. Based on the sensing capability message 520, the first communication device 100 may operate in the first transmission mode TM1 or in the second transmission mode TM2. Thus, the first communication device 100 may be based on the sensing capability of the second communication device 300 determine to operate in the first transmission mode TM1 or in the second transmission mode TM2. The transmission may in this way be adapted to the sensing capabilities of the second communication device 300.

In step II FIG. 9, a sensing transmission is requested. Sensing may be requested by the first communication device 100 or by the second communication device 300 using a sensing request message 510, 510′. When the second communication device 300 transmits a sensing request message 510 to the first communication device 100, the sensing request message 510 indicates reception of the joint data and sensing signal. The second communication device 300 transmits the sensing request message 510 to the first communication device 100 previous to receiving the joint data and sensing signal. Using the sensing request 510, the second communication device 300 may indicate that it wants to and/or are ready to receive a joint data and sensing signal.

When the first communication device 100 transmits a sensing request message 510′ to the second communication device 300, the sensing request message 510′ indicates transmission of the joint data and sensing signal. Using the sensing request 510′, the first communication device 100 may indicate to the second communication device 300 that a joint data and sensing signal will be transmitted.

In step III in FIG. 9, the first communication device 100 transmits a transmission mode message 530 to the second communication device 300, the transmission mode message 530 indicating the first communication device 100 transmitting the data signal or the joint data and sensing signal. The transmission mode message 530 may be any of: a downlink control information (DCI), a radio resource control (RRC) or a synchronization signal block (SSB).

The second communication device 300 receives the transmission mode message 530 from the first communication device 100 and hence obtains the indicating whether the first communication device 100 transmits the data signal or the joint data and sensing signal, i.e., the indication about which transmission mode TM1, TM2 is used by the first communication device 100.

In embodiments, the transmission mode message 530 further indicates one or more parameters for the joint data and sensing signal in the group comprising: a start time instance, a stop time instance, a transmission bandwidth, and a sensing signal waveform. The start and stop time instances may define when the joint data and sensing signal is transmitted, and the transmission bandwidth may define the bandwidth of the joint data and sensing signal transmission. The sensing waveform may e.g., be defined by a sensing sequence in time/frequency/space, a pulse repetition interval (PRI), a coherent pulse interval (CPI), etc. The sensing signal waveform may e.g., be a pulse radar-like waveform comprising a number of pulses in time with a specific pattern. For example, the transmitter may send N pulses in time. If each pulse has a duration Tp, and only 1 pulse is transmitted over a PRI denoted T, the CPI becomes N*T which is the whole observation time for sensing. The transmission mode message 530 may hence indicate information enabling the second communication device 300 to receive and decode the joint data and sensing signal.

Based on the transmission mode message 530, the first communication device 100 and the second communication device 300 configure to the selected transmission mode and reception mode, respectively, in step IV in FIG. 9. The transmission and reception mode may e.g., be selected based on the sensing request message 510, 510′ and/or the sensing capability message 520. In the shown embodiment, it is assumed that the sensing request message 510, 510′ has been transmitted and that the second communication device 300 supports sensing, the first communication device 100 hence tunes to sensing and starts to operate in the second transmission mode TM2, while the second communication device 300 starts to operate in the second reception mode RM2.

In step V, the first communication device 100 operates in the second transmission mode TM2 after having received the sensing request message 510 from the second communication device 300 or after having transmitted the sensing request message 510′ to the second communication device 300. The sensing request message 510, 510′ indicates reception or transmission of the joint data and sensing signal. The first communication device 100 hence transmits joint data and sensing signals to the second communication device 300. The second communication device 300 receives the joint data and sensing signals and may perform sensing measurements of the sensing parts of the joint the data and sensing signals. As previously described, the sensing part may either be received as separate signals or superimposed with data signals.

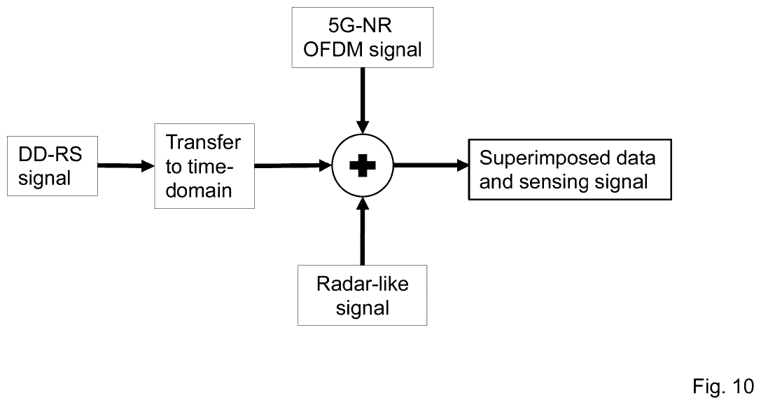

According to a 3GPP implementation of the invention, to transmit the sensing signal, a specific delay-Doppler-spatial domain sensing reference signals may be used for each transceiver of the first communication device 100, i.e., multiplexing orthogonal sensing sequences for each transceiver. A time-domain corresponding signal may then be generated. This transmission scheme may also include OFDM-based sensing signals. Furthermore, any radar-like signal can be used. For the second transmission mode TM2 with separate data and sensing signals, the sensing signal may be transmitted over t number of sensing resource elements. For the second transmission mode TM2 with superimposed data and sensing signals, the sensing signal may be added with the 5G-NR OFDM signal and then the superimposed data and sensing signal is transmitted. For example, as shown in FIG. 10 a sensing waveform can be generated based on a delay-Doppler domain reference signal (DD-RS) transferred to the time-domain or based on any radar-like signal in the time domain for sensing and tracking. The sensing waveform can then be superimposed on the 5G-NR OFDM signal or the 5G DFTs-OFDM signal to generate a superimposed data and sensing signal. At the second communication device 300, by receiving the sensing signal either as a separate signal or a superimposed signal, the sensing processing may be performed to estimate the sensing parameters. Sensing reference signal parameters may be defined in the transmission mode configuration.

A first communication device herein may also be denoted as a network access node or a client device and a second communication device herein may be denoted as a network access node or a client device.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions.

Furthermore, any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the first communication device and the second communication device comprise the necessary communication capabilities in the form of e.g., functions, means, units, elements, etc., for performing or implementing embodiments of the invention. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first communication device and the second communication device may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

What is claimed is:

1. An apparatus, comprising: one or more processors configured to:
operate in a first transmission mode (TM1) comprising transmitting a data signal to a second communication device (300); and
operate in a second transmission mode (TM2) comprising transmitting a joint data and sensing signal to a second communication device (300).

2. The apparatus according to claim 1, wherein the joint data and sensing signal comprises a data signal superimposed on a sensing signal, or vice versa.

3. The apparatus according to claim 1, further configured to:
operate in the second transmission mode (TM2) after having received a sensing request message (510) from the second communication device (300) or after having transmitted a sensing request message (510′) to the second communication device (300), the sensing request message (510, 510′) indicating reception or transmission of the joint data and sensing signal.

4. The apparatus according to according to claim 1, further configured to:
receive a sensing capability message (520) from the second communication device (300), the sensing capability message (520) indicating a sensing capability of the second communication device (300); and
operate in the first transmission mode (TM1) or in the second transmission mode (TM2) based on the sensing capability message (520).

5. The apparatus according to claim 1, further configured to: transmit a transmission mode message (530) to the second communication device (300), the transmission mode message (530) indicating the first communication device (100) transmitting the data signal or the joint data and sensing signal.

6. The apparatus according to claim 5, wherein the transmission mode message (530) further indicates one or more parameters for the joint data and sensing signal in the group comprising: a start time instance, a stop time instance, a transmission bandwidth, and a sensing signal waveform.

7. The apparatus according to claim 5, wherein the transmission mode message (530) is any of: a downlink control information, DCI, a radio resource control, RRC, or a synchronization signal block, SSB.

8. An apparatus, comprising: one or more processors configured to:
operate in a first reception mode (RM1) comprising receiving a data signal from a first communication device (100); and
operate in a second reception mode (RM2) comprising receiving a joint data and sensing signal from a first communication device (100).

9. The apparatus according to claim 8, wherein the joint data and sensing signal comprises a data signal superimposed on a sensing signal, or vice versa.

10. The apparatus according to claim 8, configured to:
transmit a sensing request message (510) to the first communication device (100) previous to receiving the joint data and sensing signal, the sensing request message (510) indicating reception of the joint data and sensing signal.

11. The apparatus according to claim 8, further configured to:
transmit a sensing capability message (520) to the first communication device (100), the sensing capability message (520) indicating a sensing capability of the second communication device (300).

12. The apparatus according to claim 8, further configured to:
receive a transmission mode message (530) from the first communication device (100), the transmission mode message (530) indicating the first communication device (100) transmitting the data signal or the joint data and sensing signal.

13. The apparatus according to claim 12, wherein the transmission mode message (530) further indicates one or more parameters for the joint data and sensing signal in the group comprising: a start time instance, a stop time instance, a transmission bandwidth, and a sensing signal waveform.

14. A method (200) for a first communication device (100), the method (200) comprising:
operating (202) in a first transmission mode (TM1) comprising transmitting a data signal to a second communication device (300); and
operating (204) in a second transmission mode (TM2) comprising transmitting a joint data and sensing signal to a second communication device (300).
